(19) United States
(12) Patent Application Publication
(10) Pub. No.: US 2013/0074471 A1
(43) Pub. Date: Mar. 28, 2013

(54) TURBINE COMBUSTOR AND METHOD FOR TEMPERATURE CONTROL AND DAMPING A PORTION OF A COMBUSTOR

(71) Applicants: Abdul Rafey KHAN, Greenville, SC (US); David William CIHLAR, Greenville, SC (US)

(72) Inventors: Abdul Rafey KHAN, Greenville, SC (US); David William CIHLAR, Greenville, SC (US)

(73) Assignee: GENERAL ELECTRIC COMPANY, Schenectady, NY (US)

(21) Appl. No.: 13/240,290

(22) Filed: Sep. 22, 2011

(51) Int. Cl. F02C 9/00; F02C 3/14

(52) U.S. Cl. 60/39.24; 60/722

(57) ABSTRACT

According to one aspect of the invention, a turbine combustor includes an outer member coupled to a wall of the combustor, wherein there is at least one damping hole formed in outer member. The turbine combustor further includes at least one temperature control hole formed in the wall wherein the at least one temperature control hole is formed at an angle with respect to a line perpendicular to a hot gas path in the combustor.

### BACKGROUND OF THE INVENTION

The subject matter disclosed herein relates to turbines. More particularly, the subject matter relates to combustion dynamics control and temperature control of a turbine.

In a gas turbine engine, a combustor converts chemical energy of a fuel or an air-fuel mixture into thermal energy. The thermal energy is conveyed by a fluid, often air from a compressor, to a turbine where the thermal energy is converted to mechanical energy. Several factors influence the efficiency of the conversion of thermal energy to mechanical energy. The factors may include blade passing frequencies, fuel supply fluctuations, fuel type and reactivity, combustor head-on volume, fuel nozzle design, air-fuel profiles, flame shape, air-fuel mixing, flame holding, combustion temperature, turbine component design, hot-gas-path temperature dilution, and exhaust temperature.

For example, high combustion temperatures in selected locations in the turbine engine, such as the combustor, may enable improved combustion efficiency and power production. In some cases, high temperatures may shorten the life and increase wear and tear of certain components.

In addition, effective operation of turbine engines may also involve managing combustion dynamics, i.e., dynamic instabilities in operation. Dynamics are often caused by fluctuations in such conditions as the temperature of exhaust gases and oscillating pressure levels within regions of the turbine, such as within the combustor. High dynamics can limit hardware life and operability of an engine, due to such factors as mechanical and thermal fatigue.

### BRIEF DESCRIPTION OF THE INVENTION

According to one aspect of the invention, a turbine combustor includes an outer member coupled to a wall of the combustor, wherein there is at least one damping hole formed in outer member. The turbine combustor further includes at least one temperature control hole formed in the wall wherein the at least one temperature control hole is formed at an angle with respect to a line perpendicular to a hot gas path in the combustor.

According to another aspect of the invention, a method for temperature control and damping a portion of a combustor includes flowing a treatment fluid through at least one damping hole in an outer member coupled to a wall of the combustor, wherein the outer member forms a resonator cavity that receives the treatment fluid. The method further includes flowing the treatment fluid from the resonator cavity through at least one temperature control hole formed in the wall, wherein the at least one temperature control hole is formed at an angle with respect to a line perpendicular to a hot gas path in the combustor.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of an embodiment of a gas turbine system;

FIG. 2 is a sectional detailed view of a portion of an exemplary combustor; and

FIG. 3 is a sectional detailed view of a portion of another exemplary combustor.

The detailed description explains embodiments of the invention, together with advantages and features, by way of example with reference to the drawings.

### DETAILED DESCRIPTION OF THE INVENTION

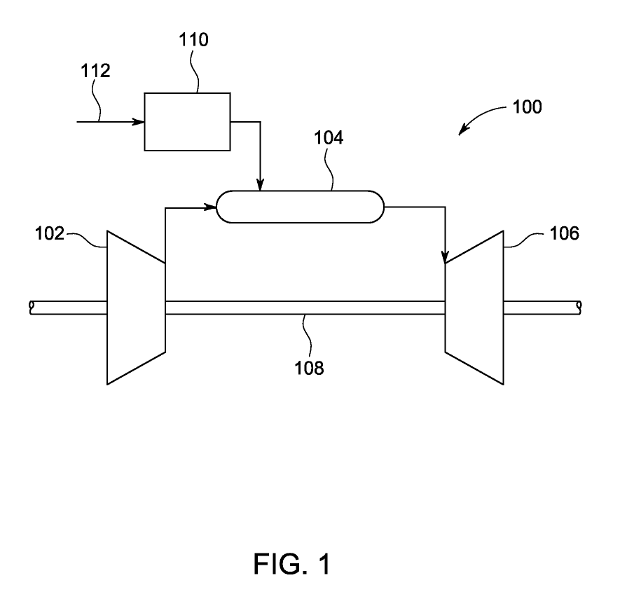

FIG. 1 is a schematic diagram of an embodiment of a gas turbine system 100. The system 100 includes a compressor 102, a combustor 104, a turbine 106, a shaft 108 and a fuel nozzle 110. In an embodiment, the system 100 may include a plurality of compressors 102, combustors 104, turbines 106, shafts 108 and fuel nozzles 110. As depicted, the compressor 102 and turbine 106 are coupled by the shaft 108. The shaft 108 may be a single shaft or a plurality of shaft segments coupled together to form shaft 108.

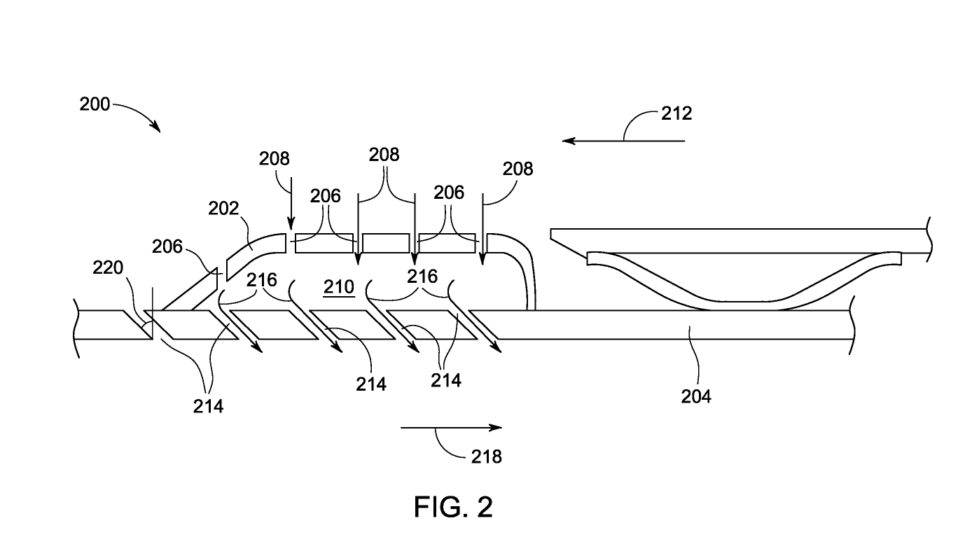

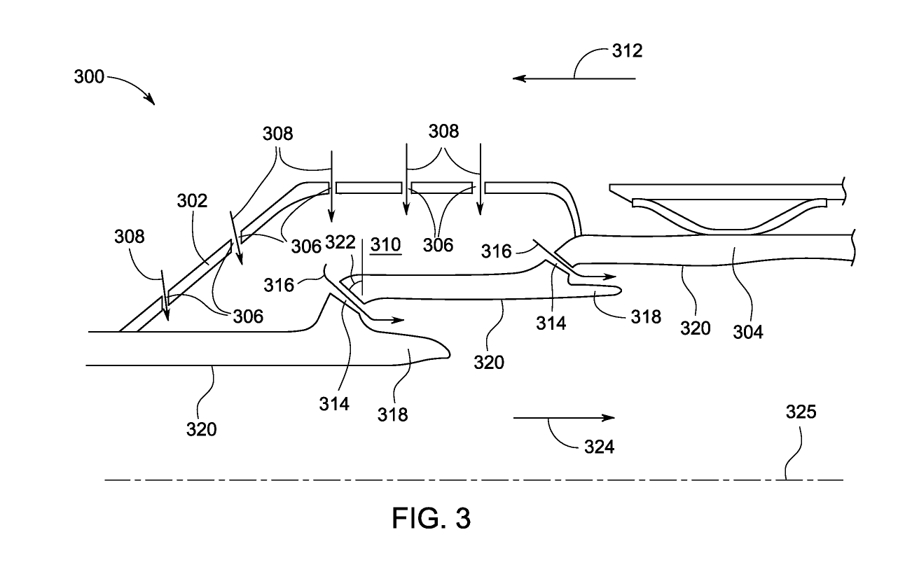

In an aspect, the combustor 104 uses liquid and/or gas fuel, such as natural gas or a hydrogen rich synthetic gas, to run the turbine engine. For example, fuel nozzles 110 are in fluid communication with a fuel supply and pressurized air from the compressor 102. The fuel nozzles 110 create an air-fuel mix, and discharge the air-fuel mix into the combustor 104, thereby causing a combustion that creates a hot pressurized exhaust gas. The combustor 104 directs the hot pressurized exhaust gas through a transition piece into a turbine nozzle (or “stage one nozzle”), causing turbine 106 rotation as the gas exits the nozzle or vane and gets directed to the turbine bucket or blade. The rotation of turbine 106 causes the shaft 108 to rotate, thereby compressing the air as it flows into the compressor 102. In an embodiment, hot gas flow through portions of the turbine, such as the combustor 104, causes wear and thermal fatigue of turbine parts, due to non-uniform temperatures. Controlling the temperature of parts of the combustor 104 can reduce wear and enable higher combustion temperatures, thereby improving performance. In addition, oscillations and vibration due to pressure changes and combustion, i.e. combustion dynamics, can also wear portions of the combustor 104. Combustion dynamics may be controlled and reduced by selected mechanisms, such as resonators, to reduce wear and improve life of the combustor 104. Controlling combustion dynamics of and temperatures of the combustor 104 are discussed in detail below with reference to FIGS. 2-3.

FIG. 2 is a detailed sectional view of a portion of an exemplary combustor 200. The combustor 200 includes an outer member 202 coupled to an outer side of a wall 204. One or more holes 206 or passages are formed in the outer member 202 to enable fluid flow 208 to a cavity 210 formed within the outer member 202 and wall 204. In an embodiment, the outer member 202 and holes 206 (also referred to as “damping holes”) form a resonator apparatus coupled to the wall 204 to control and reduce combustion dynamics. As depicted, a cooling fluid flow 212 (also referred to as “treatment fluid”), such as an air flow, supplies the fluid flow 208 into the cavity 210. The wall 204 also includes one or more holes 214 or passages for directing fluid flow 216 inside the combustor toward a hot gas path 218 or flow. The holes 214 (also referred to as “cooling holes” or “temperature control holes”) may be located outside or within the outer member 202, wherein the holes within the outer member 202 are in fluid communication with the cavity 210. In an embodiment, the holes 214 are formed at an angle 220 with respect to a line perpendicular to the hot gas path 218. The holes enable effusion temperature control and cooling of the combustor 200 and wall 204 via the fluid flow 216. In embodiments, the angle 220 ranges from about 10 to about 80 degrees. In other embodiments, the angle 220 ranges from about 15 to about 60 degrees. In yet other embodiments, the angle 220 ranges from about 15 to about 45 degrees. It should be understood that examples may include discussion of cooling the combustor 20, however, embodiments may also include temperature control or treatment of the combustor, wherein the temperature of the combustor is maintained at a temperature or is allowed to rise at a selected rate.

FIG. 3 is a detailed sectional view of a portion of an exemplary combustor 300. The combustor 300 includes an outer member 302 coupled to an outside portion of a wall 304. One or more holes 306 or passages are formed in the outer member 302 to enable fluid flow 308 to a cavity 310 formed within the outer member 302 and wall 304. In an embodiment, the outer member 302 and holes 306 (also referred to as “damping holes”) form a resonator apparatus coupled to the combustor 300 to control and reduce combustion dynamics. As depicted, a portion of a cooling fluid flow 312 (also referred to as “treatment fluid”), such as an air flow, forms the fluid flow 308 that is directed into the cavity 310. The wall 304 also includes one or more holes 314 or passages (also referred to as “cooling holes” or “temperature control holes”) configured to direct fluid flow 316 inside the combustor 300 and along one or more members 318 formed on an inner side 320 of the wall 304. The members 318 are configured to direct the fluid flow 316 along the inner side 320, to enable cooling of the wall 304. The members 318 may be any suitable shape to cause fluid flow 316 in a desired direction, such as airfoils, blades, ridges, wings or any other suitable geometry. As depicted, the members 318 are laterally offset or staggered, but may be arranged in any suitable fashion to control temperature of portions of the combustor 300 via fluid flow 316. In embodiments, the members 318 create a flow component for fluid flow 316 that is substantially parallel to a hot gas path 324 and an axis 325 of the combustor 300. In an embodiment, the holes 314 may be located outside or within the outer member 302, wherein the holes within the outer member 302 are in fluid communication with the cavity 310. Further, exemplary holes 314 may include one or more holes proximate members 318 while additional holes 314 may be positioned substantially away or removed from members 318. In an embodiment, the holes 314 are formed at an angle 322 with respect to a line perpendicular to the hot gas path 324, thus enabling cooling of at lease a portion of the combustor 300 and wall 304 via the fluid flow 316. In embodiments, the angle 322 may range from about 10 to about 80 degrees. In other embodiments, the angle 322 may range from about 15 to about 60 degrees. In yet other embodiments, the angle 322 may range from about 15 to about 45 degrees.

The holes 206, 214, 306, 314 may be any suitable geometry and orientation configured to direct fluid flow to portions of the combustors 200, 300. Exemplary geometries of the cross-sectional flow area of the holes may be circular, rectangular, oval, ellipses, rectangles or other suitable shapes. In embodiments, the cooling fluid flow 212, 312 outside the wall 204, 304 of the combustor 200, 300 and between about 400 and about 800 degrees Fahrenheit (F). In addition, temperatures of the combustors 200, 300 inside the walls 204, 304 range from about 2500 to about 3500 degrees F. Therefore, the flow of the cooling fluid 212, 312 to fluid flows 208, 308 and 214, 314 inside the combustors 200, 300 (and along with members 318 for combustor 300) provide improved temperature control and/or cooling to reduce wear for the turbine components. Further, the arrangement of the outer member 202, 302 and holes 206, 306 act as a resonating apparatus to provide damping and control combustion dynamics. In embodiments, the outer members 202, 302 are coupled to walls 204, 302 to form Hemholtz resonators configured to provide damping and control combustion dynamics. In an embodiment, the resonators are tuned to combustion dynamics frequency and are thereby configured to cause damping of combustion dynamics at the selected frequency. Accordingly, the depicted arrangement improves turbine reliability and performance by improving temperature control while controlling combustion dynamics for the exemplary combustors 200, 300. In embodiments the depicted portions of the combustors 200, 300 may be any portion of the combustor, including but not limited to the liner or cap region.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A turbine combustor comprising:
an outer member coupled to a wall of the combustor, wherein there is at least one damping hole formed in the outer member; and
at least one temperature control hole formed in the wall wherein the at least one temperature control hole is formed at an angle with respect to a line perpendicular to a hot gas path in the combustor.

2. The turbine combustor of claim 1, wherein a plurality of damping holes are formed in the outer member.

3. The turbine combustor of claim 1, wherein a plurality of temperature control holes are formed in the wall, wherein the plurality of temperature control holes are formed at the angle with respect to the line perpendicular to the hot gas path.

4. The turbine combustor of claim 3, wherein the plurality of temperature control holes are each formed at an angle of about 10 to about 80 degrees with respect to the line perpendicular to the hot gas path.

5. The turbine combustor of claim 3, comprising a plurality of members formed on an inner side of the wall, wherein each member is proximate each temperature control hole, the plurality of members configured to direct a treatment fluid along the inner side of the wall.

6. The turbine combustor of claim 1, wherein the at least one temperature control hole is formed at the angle of about 10 to about 80 degrees with respect to the line perpendicular to the hot gas path, the at least one temperature control hole providing effusion temperature control for the wall.

7. The turbine combustor of claim 1, comprising at least one member formed on an inner side of the wall and proximate the at least one temperature control hole, the at least one member configured to direct a treatment fluid along the inner side of the wall.

8. The turbine combustor of claim 1, wherein the outer member coupled to the wall of the combustor forms a Hemholtz resonator tuned to a combustion dynamics frequency.

9. An apparatus for damping and controlling a temperature of a portion of a combustor, the apparatus comprising:
an outer member coupled to a wall of a combustor part, at least one damping hole formed in the outer member for damping and receiving a treatment fluid, thereby forming a resonator cavity;
at least one temperature control hole formed in the wall, wherein the temperature control hole is configured to direct the treatment fluid from the resonator cavity toward a hot gas path inside the wall of the combustor part; and
at least one member formed on an inner side of the wall and proximate the at least one temperature control hole, the at least one member configured to direct the treatment fluid along the inner side of the wall.

10. The apparatus of claim 9, wherein the at least one temperature control hole is formed at an angle with respect to a line perpendicular to a hot gas path in the combustor.

11. The apparatus of claim 9, wherein a plurality of damping holes are formed in the outer member.

12. The apparatus of claim 9, wherein a plurality of temperature control holes are formed in the wall, wherein the plurality of temperature control holes are formed at an angle with respect to a line perpendicular to a hot gas path in the combustor.

13. The apparatus of claim 12, wherein the plurality of temperature control holes are each formed at an angle of about 10 to about 80 degrees with respect to the line perpendicular to the hot gas path in the combustor.

14. The apparatus of claim 12, comprising a plurality of members formed on the inner side of the wall, wherein each member is proximate each temperature control hole, the plurality of members configured to direct a treatment fluid along the inner side of the wall.

15. The apparatus of claim 9, wherein the at least one temperature control hole is formed at an angle of about 10 to about 80 degrees with respect to a line perpendicular to a hot gas path in the combustor, the at least one temperature control hole providing effusion temperature control for the wall.

16. A method for temperature control and damping a portion of a combustor, the method comprising:
flowing a treatment fluid through at least one damping hole in an outer member coupled to a wall of the combustor, wherein the outer member forms a resonator cavity that receives the treatment fluid; and
flowing the treatment fluid from the resonator cavity through at least one temperature control hole formed in the wall, wherein the at least one temperature control hole is formed at an angle with respect to a line perpendicular to a hot gas path in the combustor.

17. The method of claim 16, wherein flowing the treatment fluid through at least one damping hole comprises flowing the treatment fluid through a plurality of damping holes in the outer member.

18. The method of claim 16, wherein flowing the treatment fluid through at least one temperature control hole comprises flowing the treatment fluid through a plurality of temperature control holes, wherein the plurality of temperature control holes are formed at the angle with respect to the line perpendicular to the hot gas path.

19. The method of claim 18, wherein flowing the treatment fluid through the plurality of damping holes comprises flowing the treatment fluid through the plurality of damping holes and proximate a plurality of members formed on an inner side of the wall, the plurality of members configured to direct the treatment fluid along the inner side of the wall.

20. The method of claim 16, wherein flowing the treatment fluid through at least one temperature control hole comprises flowing the treatment fluid through the at least one temperature control hole proximate at least one member formed on an inner side of the wall, the at least one member configured to direct the treatment fluid along the inner side of the wall.
